(19) United States
(12) Patent Application Publication
(10) Pub. No.: US 2025/0018513 A1
(43) Pub. Date: Jan. 16, 2025

(54) DEVICE FOR PRODUCING AND/OR PROCESSING OBJECTS AND METHOD FOR PRODUCING AND/OR PROCESSING AN OBJECT

(71) Applicant: MULTIVATIVE GMBH, Graz (AT)

(72) Inventors: Elias VÖGEL, Graz (AT); Laurenz FUSSENEGGER, Graz (AT)

(21) Appl. No.: 18/689,647

(22) PCT Filed: Aug. 29, 2022
(86) PCT No.: PCT/EP2022/073985

§ 371 Date: Mar. 6, 2024

(30) Foreign Application Priority Data
Sep. 7, 2021 (DE) 10 2021 123 180.9

(51) Int. Cl. B23Q 3/155

(52) U.S. Cl. CPC B23Q 3/15503

(57) ABSTRACT

The disclosure relates to an apparatus for manufacturing and/or processing of objects. Tools can be attached both to a work holder and to one or more rest holders, and can therein be connected with control interfaces for electrical connection to at least one respective control unit. The disclosure relates further to a corresponding method.

The invention relates to an apparatus for manufacturing and/or processing objects and an associated method.

The production of objects such as machine parts was, in earlier times, carried out primarily by machining or other abrasive processing, typically using a blank from which unneeded parts were removed. In recent years, however, it has been shown that additive manufacturing processes have advantages in numerous applications, in particular they are more flexible and require less material. It has also been shown that many other manufacturing technologies are useful in the production of circuit boards, for example when assembling circuit boards with electronic components.

It is an object of the invention to provide an apparatus for manufacturing and/or processing objects which is designed alternatively or better than known designs. It is a further object of the invention to provide an associated method. This is achieved according to the invention by an apparatus and a method according to the respective main claims. Advantageous embodiments can be found, for example, in the respective subclaims. The content of the claims is made a content of the description by explicit reference.

The invention relates to an apparatus for manufacturing and/or processing objects. The apparatus has a work holder to which a tool can be releasably attached. The apparatus has a manipulator to which the work holder is attached and with which the work holder can be variably positioned. The apparatus has one or more rest holders, wherein at each rest holder a tool is releasably attachable. The apparatus has one or more control interfaces for electrical connection to at least one control unit. Both the work holder and at least one rest holder expediently each have one or more connectors for connection to a tool attached thereto, the connectors of the work holder and of the at least one rest holder being electrically connected to at least one control interface.

With such an apparatus, a tool can be held in the rest holder while it is not needed and can be picked up by means of the work holder while it is in use, in both cases controlling and/or supplying the tool by means of a control unit connected to a control interface is possible. The operation of the apparatus can be significantly simplified in this way. In particular, direct lines to the tool, for example flexible lines that are permanently attached to it, can be omitted. This makes it easier to exchange tools and to use new tools, and increases the range of use of the tools.

The apparatus can in particular represent a 3D printer or be designed as a 3D printer.

Manufacturing objects can be understood in particular to mean that an object as such is created. This can be done, for example, as part of additive manufacturing. For example, a material is kept in stock by a tool and applied in such a way that the object, a part of it or a part that then has to be processed is created. Processing objects can in particular be understood as meaning that an already existing object is changed by removing material or applying material. An object can also be, for example, a circuit board which is equipped with various electrical and/or electronic components or on which other processing is carried out. However, it can also be other kinds of objects.

The work holder is in particular the holder to which a tool is attached when it is currently being used. Using the manipulator, the work holder can be moved so that it can be moved to a required location. For example, it can be placed near an object to be processed or to be manufactured. The manipulator can, for example, enable three-dimensional positioning of the work holder. It can also enable two-dimensional or one-dimensional positioning. Multi-dimensional, for example four-dimensional, five-dimensional or six-dimensional positioning is also possible. In this case, for example, one or more axes of rotation, for example one axis of rotation, two axes of rotation, or three axes of rotation, can be controlled. The manipulator can in particular be controlled in a targeted manner in order to position the work holder precisely.

The rest holders can in particular be designed to hold a respective tool when it is not currently needed. In particular, this also allows an automatic tool change, since the apparatus itself can hold all the tools provided on its rest holders and these can be picked up by the work holder if necessary. The tools can also be contacted electrically in the rest holders, so that, for example, a warm-up phase can be carried out in the rest holder, data can be exchanged, checks can be carried out or the tool can be provided with new consumables. The control interfaces are, in particular, interfaces that can be connected to a respective control unit. For example, a control interface can be a slot for a plug-in card, and accordingly a control unit can in particular be a plug-in card that can be plugged into a control interface. The control interface can, for example, have contacts, and the control unit can have complementary contacts in order to establish an electrical connection between the control unit and the control interface. However, other designs can also be used. A control interface can also form a respective fixed, for example hard-wired, connection to a control unit. In the case of a control interface, this can be referred to as a permanently connected contact. If the control unit can be removed without mechanically loosening the connection, it can be said to have an open contact.

A connector can, for example, be a contact that can establish an electrical connection between the tool and the respective holder. It can be provided that one or more contacts are present in the work holder, it can also be provided that one or more contacts are provided in a respective rest holder, which are designed in the same way and which can therefore contact the tool as if it were contacted by the contacts of the work holder. However, different types of contacts can also be provided in the working holder and the rest holder. In particular, fewer contacts can be used in a rest holder than in the work holder, for example if not all functionalities are required in the rest holder.

It should be understood that in principle there is at least one work holder and at least one rest holder, but that several rest holders can also be present. It is also possible to have multiple work holders. These can, for example, be adapted to different observation tasks. It is further understood that in principle at least one of the rest holders each has one or more connectors for connection to a tool attached thereto, and that further rest holders can also be present which do not have such connectors or have other types of connectors. In principle, several or all rest holders can have corresponding connectors.

The apparatus, in its previously described form, is configured to interact with one or more tools and one or more control units. Tools and/or control units do not necessarily have to be part of the apparatus. However, these can also be part of the apparatus.

It can be provided that a line comes out of one, some or all connectors of the rest holders, which is electrically connected to a contact of one, some or each control interface. Such a line can be used to directly supply the respective connector with electrical power and/or data communication and/or signal communication from the control interface or a control unit connected to it. It can be provided that a line extends from one, some, or all connectors of the work holder, wherein the line is electrically connected to a contact of a control interface, some control interfaces, or each control interface. This allows a tool to be supplied appropriately through the contacts of the work holder.

In particular, it can be provided that for one or more connectors of the rest holder, an associated connector of the work holder is connected to the same control interface and/or to the same contact of the control interface. Such connections can also be designed to be switchable. A functionality can thus be controlled or supplied equivalently in the rest holder and in the work holder.

A connector is to be understood in particular as an element which is designed to exchange electrical energy, data, or a fluid or other substance with the tool. A pure detector that detects the presence of a tool is not considered a connector.

The control interfaces can in particular be designed to be similar to one another. This allows simple modular exchange of control units. In particular, they can be arranged, for example, in a control cabinet, which provides mechanical protection for the control interfaces and control units. However, different types of control interfaces can also be used in an apparatus.

According to an implementation, the apparatus can have a compressed air supply and/or a vacuum supply for the work holder. The compressed air supply and/or the vacuum supply can in particular be controllable from a central control unit and/or from control units connected to the control interfaces. Such an embodiment allows a tool to be supplied with compressed air and/or with negative pressure, wherein compressed air can, for example, refer to a pressurized air stream, whereas negative pressure can be provided through a line which is brought to a pressure below atmospheric pressure. This can be done, for example, by a vacuum pump or another pump. Compressed air can be provided, for example, by a compressor. The central control unit can in particular be a control unit which is present in addition to the control units connected to the control interfaces. The central control unit can in particular take on central functions, for example the control of the compressed air supply and/or vacuum supply as just mentioned and/or the control of the manipulator or other components of the apparatus. The central control unit can be designed, for example, as a plug-in card or as a computer, microprocessor, microcontroller, programmable logic controller (SPSS), application-specific integrated circuit (ASIC=Application Specific Integrated Circuit) or as another programmable or hard-wired unit. The same applies to the design of the control units.

Compressed air and/or a negative pressure can be used in particular for a tool change, for example a tool can be held by negative pressure or can be moved by compressed air. Compressed air or vacuum-operated components can also be provided in the tools, which can be supplied as just described. For example, compressed air can be used to drive a turbine or another element in a tool to drive a drill or another processing unit. Negative pressure can be used, for example, to suck another component or a part to be machined onto the tool.

According to an implementation, the apparatus has one or more electrical power supplies for the work holder and/or the rest holders. The electrical power supply can in particular be controllable from a central control unit and/or from one or more control units connected to the control interfaces. This allows a central power supply for the tools, so that such a power supply does not need to be provided via the control interfaces. Alternatively or additionally, such power supply can also take place via the control interfaces. The electrical power supply as just described has the basic advantage that it can be implemented separately and can typically be designed to be more powerful. In an exemplary embodiment, 230 V/10 A can be transmitted simultaneously via four contacts. Overall, a maximum of 230 V/20 A (with guaranteed inflow and outflow) would be possible, which corresponds to an output of up to 4 KW. For example, it can be a high-power supply. Using the power provided, heating elements, electric motors, relays, actuators or lamps can be operated in the tools, for example. With regard to the central control unit, reference is made to the above statements.

According to an implementation, the apparatus may have at least one multiplexer that is designed to selectively connect one of a plurality of electrical power supplies to one or more connectors of the working holder and/or the rest holders. As a result, a suitable power supply can be selected from among several power supplies as required, and the electrical power can be provided at a suitable location on the work holder and/or on one or more of the rest holders.

Each control interface, or even just one or some of the control interfaces, can in particular have one or more electrical contacts, each contact being electrically connected to one or more connectors and being electrically connectable to a control unit. The connectors are in particular those that were already mentioned above. The contacts can be designed, for example, as flags or surfaces, and are in particular electrically conductive. The contacts of the control interfaces can, for example, be designed as plug connectors according to DIN 41612, which can be plugged into one another.

In particular, some or all connectors can be designed as electrical contacts or as plugs. An electrical contact can, for example, be a conductive part of the surface that is connected to a line. For example, a complementary conductive part of the tool can contact this conductive part of the surface and thus establish an electrical connection. A plug can, for example, be designed so that it snaps into place and/or makes contact of mutually complementary, protruding and/or indented components. Some or all connectors can be designed as spring contacts.

In particular, each rest holder can have one or more connectors for connection to a tool attached to it. However, additional rest holders can be provided, which, for example, have no connectors for connecting to a control interface, but can still have one or more connectors for identifying a tool. However, rest holders can also be provided which do not have any connectors for connection to a tool.

In particular, the control interfaces can be designed as slots for control units in the form of electrical plug-in cards. This allows a simple design and, in particular, a simple replacement of the plug-in cards. The control interfaces and/or slots can in particular be arranged in a control cabinet or another enclosed housing, whereby they can be protected from mechanical damage, dust and also from unauthorized replacement or manipulation.

The work holder can in particular be positioned automatically and/or electrically or electronically controllably by means of the manipulator. This allows precise positioning of the work holder and thus a tool attached to it, wherein, for example, a three-dimensional coordinate system or a cylindrical coordinate system or spherical coordinate system can be used to position the work holder.

The manipulator can in particular be designed as a portal system. This can mean, for example, that a beam can be moved along a holder in an x-direction, with the holder being movable in a z-direction, i.e. a height. The work holder can be moved along the beam in a y-direction, for example. The directions mentioned (x, y, z) can in particular be perpendicular to one another. In particular, an x-y-plane can span a horizontal plane.

The work holder can be positioned three-dimensionally in particular by means of the manipulator. This allows a particularly high level of flexibility. However, two-dimensional or one-dimensional positionability as well as four-, five- or six-dimensional positionability are also possible.

The tool or tools can in particular be connectable or connected to the control interfaces or control units exclusively by means of the connectors of the work holder and the rest holder or the rest holders. This can mean in particular that there is no additional connection, in particular electrical and/or pneumatic connection, to the respective tool. In prior art designs, flexible conduits are often used to power tools, regardless of whether they are in use or in a resting position. In designs known from the prior art, the flexible line is therefore always connected to the tool and limits its range of movement and interchangeability. In the apparatus described here, this can advantageously be omitted, so that tools can be replaced more easily and the radius of action is expanded.

The work holder may in particular be configured to hold a tool by applying a spring force and to release it by applying compressed air. This has proven to be an advantageous embodiment, wherein, for example, a spring can ensure latching and this latching can be released with compressed air. In particular, one or more zero-point clamps can be used.

One, some or all rest holders can each have one or more rails onto which, for example, a respective tool can be inserted from above. The tool can, for example, be placed on the bottom of the rest holder.

The rest holders can in particular be arranged adjacent to one another along a line. For example, the line can be straight or curved. This allows for a simple implementation. The connectors can be connected to the respective control interface, in particular for transmitting data and/or electrical energy between the tool and the control unit. Data can in particular be transmitted bidirectionally or only unidirectionally. In this way, for example, a tool can be controlled, wherein it can receive commands, software can be updated or measured values or other data can be read out. Electrical energy can be used in particular to drive components such as electric motors, magnets, lights, or heating elements.

The apparatus can in particular have a central control unit. For example, it can be the one already mentioned above. The central control unit can in particular be connected to one, some or all control interfaces. This allows communication between the central control unit and the respective control units that are connected to the control interfaces. The central control unit can also be connected to one, some, or all control units. This can be done, for example, using a CAN bus or another bus system. The central control unit can be designed in particular to control the manipulator. This allows the manipulator to be controlled centrally, so that not every control unit has to be able to control the manipulator. In particular, this increases the modularity, since, for example, each control unit can be assigned to one tool or several tools.

The apparatus can in particular have one or more tools which are attached to the work holder or to a respective rest holder. This is to be understood in particular functionally, i.e. each tool is attached either to the work holder or to a rest holder, with typically not more than one tool being attached to the work holder or to a respective rest holder at the same time. The apparatus can in particular have one or more control units, each control unit being connected to a control interface for controlling one or more tools. This allows, in particular, a particularly high level of modularity, since each tool can have an associated control unit, for example a plug-in card, which can be sold together with the respective tool, for example. This also enables modularity depending on customer requirements, since the apparatus itself can be constructed in such a way that it can be equipped with different tools, with each customer only having those tools and assigned control units that they actually need.

In particular, one, some or all tools may have an electronic tool identification. These tools can in particular be configured to send their electronic tool identification via at least one connector to a central control unit or to at least one control unit connected to a control interface. This allows tools to be identified. The tools may also be configured to send their electronic tool identification to a detection module. This detection module may be configured to detect a tool in the work holder and/or in one, some or all of the rest holders. It can also be configured, for example, to identify a type or a specific tool. The tool identification can, for example, be designed such that it includes an identification for the type of tool. It can also contain a unique identification of a specific tool, for example in the form of a serial number. Identification can be sent via both the rest mount and the work mount. This allows identification of a tool in both types of holders.

Different tools are listed below, wherein one tool or several tools can be taken from this list. For example, a tool for additive manufacturing, a milling tool, a sensing tool, a dispensing tool, an assembly tool, a laser engraving tool, an adhesive tool and/or a rotary knife may be present. Other tools can also be used.

Below, the typical functionality and possible connectors for some tools are given in a table, wherein the connectors refer in particular to the design of the assigned control units. It should be noted that these are typical or preferred specifications, but other functionalities, connectors and values may also be used.

| Tool | Functionalities | Connectors |
|---|---|---|
| milling tool | milling spindle on/off, | motor spindle: up to 250 V |
| (especially for | speed, actuation tool | AC, 5 A, 4 lines; |
| metal processing) | change, measurement, | temperature sensor: 24 V, |
| | overload, suction | 1 A max., 2 lines; |
| | | compressed air: |
| | | approx. 6 bar for tool |
| | | change and blowing out |
| milling tool | milling spindle on/off, | motor spindle: up to 36 V |
| (especially for | speed, actuation tool | AC, 7 A, 3 lines; |
| printed circuit | change, measurement | temperature sensor: 24 V, |
| board processing) | overload, suction | 1 A max., 2 lines; |
| | | compressed air: approx. 6 |
| | | bar for tool change and |
| | | blowing out |
| 3D printing tool | heating on/off, heating | stepper motor material |
| | temperature control, | supply: 24 V, 2 A max., 4 |
| | heating measurement | wires; |
| | actual temperature, fan | material sensor: 24 V, 1 A |
| | on/off, fan speed, material | max., 2 lines; |
| | supply on/off, material | temperature sensor: 24 V, |
| | supply speed, sensor | 1 A max., 2 lines; |
| | material, material supply | heating element: 24 V, 3 A |
| | specific length | max., 2 lines; |
| | | fans (up to 2): 24 V, 1 A |
| | | max., 2 lines each |
| measuring probe | activation/deactivation, | measuring probe: 24 V, 1 |
| tool | measurement of actual | A max., 3 lines |
| | state, notification when | |
| | triggered | |
| dosing tool | pressure control for | motor feed spindle: 24 V, |
| | compressed air feed, | 2 A max., 2 lines; |
| | material feed-spindle | limit switch: 24 V, 1 A |
| | on/off, material supply | max., 2 lines |
| | spindle speed, supply | compressed air: 1 to 3 |
| | spindle setting active time | bar, adjustable |
| assembly tool | vacuum on/off, rotation | stepper motor component |
| | component by given | rotation: 24 V, 2 A max., 4 |
| | angle, reading back | lines; |
| | current angle | limit switch: 24 V, 1 A |
| | | max., 2 lines; |
| | | vacuum valve: 24 V, 1A |
| | | max., 2 lines; |
| | | vacuum supply: 1 line; |
| | | option for second |
| | | assembly head for faster |
| | | assembly (plus stepper |
| | | motor and lifting device |
| | | for both heads) |
| laser engraving | laser on/off, power control | laser connections: |
| | | max. 24 V, 5A |
| dosage adhesive/ | feed medium on/off, | spindle drive: max. 24 V, |
| sealant | speed control | 2A |
| | | compressed air: max. 5 |
| | | bar |
| rotary knife | rotation control knife | Motor for knife rotation: |
| | | max. 24 V, 2 A |

The invention further relates to a method for manufacturing and/or processing an object, the method having the following steps:
Attaching at least one tool to a rest holder, the tool being electrically connected to a control unit assigned to the tool by means of at least one connector of the rest holder, while it is attached to the rest holder,
Releasing the tool from the rest holder and thereby attaching the tool to a work holder, the tool being electrically connected to the control unit assigned to the tool by means of at least one connector of the work holder while it is attached to the work holder,
Positioning the tool by means of a manipulator to which the work holder is attached, thereby producing and/or processing the object by means of the tool.

By means of such a method it can be ensured that each tool is always attached to the work holder or to one of the rest holders and is connected to an associated control unit via the respective holder. This allows the tool to be controlled by the respective control unit regardless of where it is currently located. Nevertheless, a permanent connection, for example in the form of a flexible cable, can be omitted. The method can in particular be carried out using an apparatus as described herein. With regard to the apparatus, all designs and variants described herein can be used. It should be understood that all features given with reference to the apparatus are also applicable to the method. The same applies in the opposite direction.

The control unit assigned to the tool can in particular be one control unit out of several control units. In particular, each tool out of several tools can be assigned exactly one control unit.

It should be understood that the method described herein can also be carried out if tools are not connected to control units via the respective holder or its connectors. For example, the method can be carried out both with tools that require a connection to a control unit and with tools that do not require such a connection. In particular, an apparatus can be designed to carry out the method described, but also, for example, to use tools that do not require a connection to a control unit.

The tool can, for example, be connected to the control unit exclusively by means of the connectors of the rest holder and/or the work holder. This means that a flexible line or other direct connections to the tool can be omitted. This increases flexibility and makes interchangeability easier.

A person skilled in the art will find further features and advantages in the exemplary embodiment described below with reference to the accompanying drawing, wherein shows:

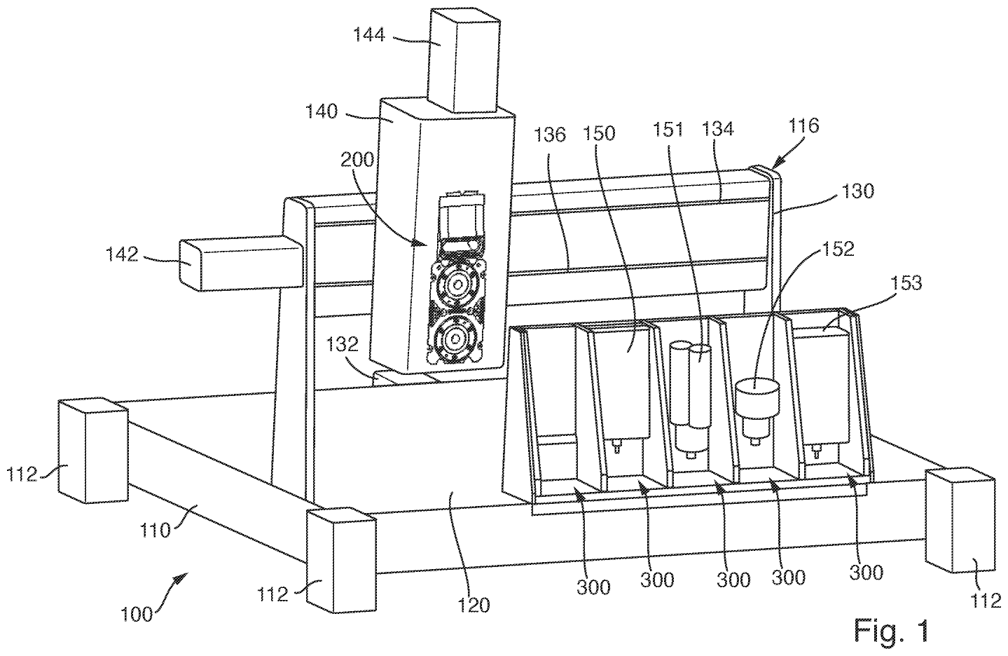

FIG. 1: an apparatus for manufacturing and/or processing objects,

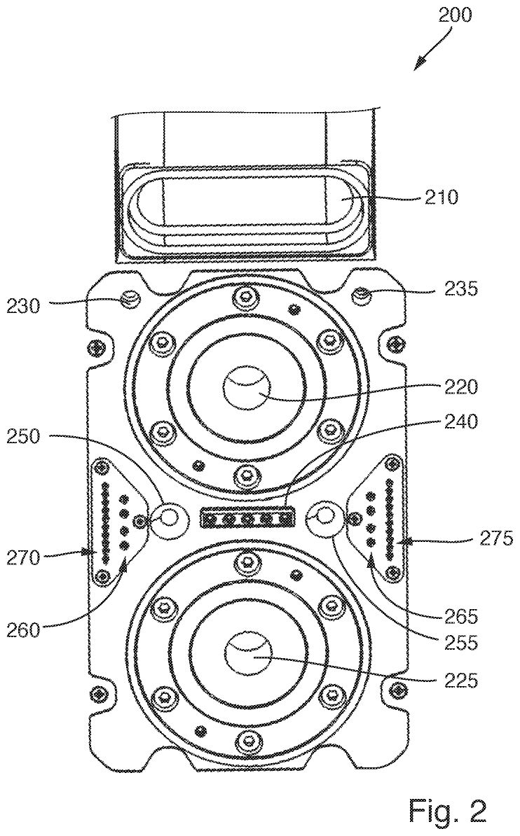

FIG. 2: a detailed view of the apparatus from FIG. 1,

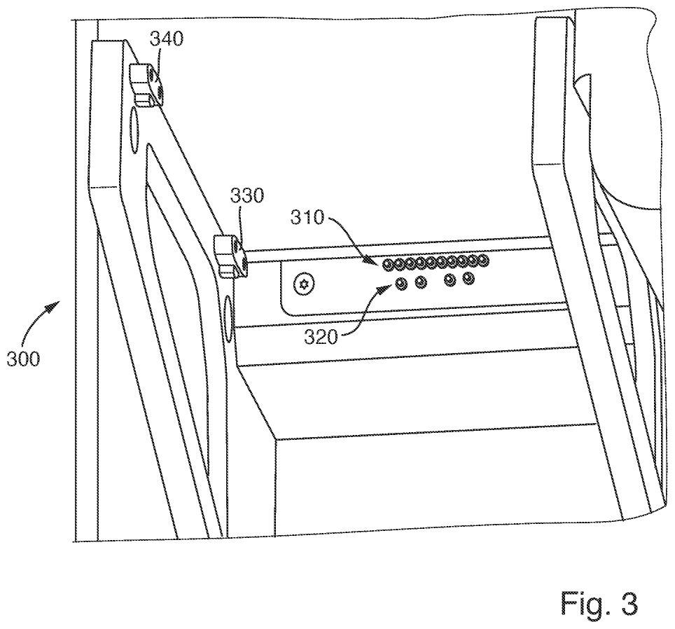

FIG. 3: a further detailed view of the apparatus from FIG. 1, and

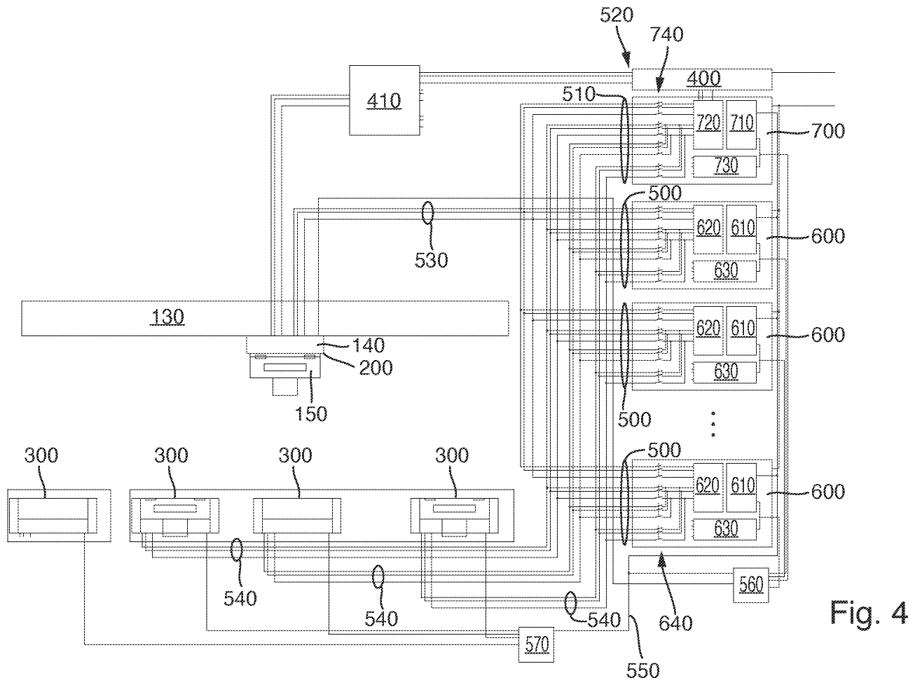

FIG. 4: an electrical circuit diagram of the apparatus from FIG. 1.

FIG. 1 shows schematically an apparatus 100 for manufacturing and/or processing objects. The apparatus 100 has a frame 110, which in the embodiment shown can stand on a floor by means of a total of four feet 112, three of the four feet 112 being visible in FIG. 1.

The frame 110 carries, among other things, a processing surface 120. Objects that are to be processed can be stored on the processing surface 120. Objects can also be created from scratch, for example by using 3D printing.

A portal 130 is also mounted on the frame 110. The portal 130 can be moved along a short side of the frame 110 by means of a first electric motor 132 attached to the rear of the frame 110. The direction along which the portal 130 can be moved as just described can be referred to as the y-direction.

A line guide (not shown) can be arranged next to the portal 130, via which lines (not shown) are routed between the frame 110 and the portal 130. Such lines can be used, for example, to provide power, compressed air or vacuum, and data and/or signal exchange.

In the present case, a first rail 134 and a second rail 136 are formed on the portal 130. These extend horizontally in the direction of the longer side of the frame 110, which can be referred to as the x-direction. In the present case, the rails 134, 136 are designed to be concealed, i.e. they are covered by flexible cover elements such as bristles.

A module holder 140 is attached to the portal 130 in such a way that it can be moved in the x-direction along the two rails 134, 136 just described. A second electric motor 142 is used for this purpose. In addition, a third electric motor 144 is provided, by means of which the module holder 140 can be moved vertically, i.e. in the z-direction. The module holder 140 can thus be freely positioned in three dimensions in space. Limits of this positioning may be dictated by the geometric conditions of the named elements.

A work holder 200 is arranged at the module holder 140. This will be described in more detail below with reference to FIG. 2. A tool can be attached to the work holder 200 in order to manufacture and/or process objects. This will be discussed in more detail below.

The apparatus 100 also has a total of five rest holders 300. The rest holders 300 serve to hold a respective tool when it is not currently needed for manufacturing and/or processing objects. The rest holders 300 are arranged directly next to one another as shown and will be described in more detail below with reference to FIG. 3.

The portal 130 and the module holder 140 can be viewed together as a manipulator 116, which can move and position the work holder 200.

The rest holder 300 located on the far left is currently not occupied by a tool.

In the shown case, an assembly tool 150 is accommodated in the second rest holder 300, viewed from the left, such an assembly tool 150 typically having a motor with a hollow shaft, with a vacuum being able to be applied in the hollow shaft. Using this vacuum, a component can be held and positioned, with the hollow shaft being rotatable by the motor. This allows the component, such as a processor or other microelectronic or electrical component, to be positioned and aligned. This can be used to equip a circuit board, for example.

In the third rest holder 300, viewed from the left, there is currently a dosing tool 151, which has, for example, a cartridge, a hose, a spindle and an electric motor. The spindle can be driven by the electric motor in order to convey material stored in the cartridge, such as solder paste or sealant, and dispense it at the bottom. This material can then be applied to an object to be processed. In the fourth rest holder 300, viewed from the left, there is a 3D measuring tool 152, which has a movable pen on the bottom, by means of which an object can be scanned. Movements of the pen, which are generated by contact with the object, can be recorded, which means that very precise information about the surface of the object can be obtained.

In the rightmost rest holder 300, there is currently a milling tool 153, which has a milling cutter on the bottom, which can be rotated by means of an electric motor. The milling tool 153 also has a suction system in order to immediately suck off any milling chips that may arise. For this purpose, a suction shoe (not shown) can be provided, which can have bristles in order to prevent milling chips from escaping to the side. The suction shoe can also be mounted floatingly, so that it can, for example, automatically adapt to the height and/or contour of an object to be processed.

It should be understood that the tools 150, 151, 152, 153 are only shown schematically and described cursorily here. Other tools, for example a 3D printing tool for delivering a material for 3D printing, can also be used, for example.

FIG. 2 shows the already mentioned work holder 200 in greater detail. An elongated hole-shaped suction 210 is initially provided on the top side. This allows, for example, milling chips to be sucked out, as already mentioned above with reference to the milling tool 153. Further down, a first zero-point clamp 220 and a second zero-point clamp 225 are provided. This means that one of the tools already mentioned or another tool can be mechanically attached to the work holder 200 in a suitable manner.

A vacuum connector 230 and a compressed air connector 235 are provided on the top side below the suction 210. This allows vacuum and compressed air to be provided. A reverse configuration is also possible. It can also be provided that a decision can be made at runtime as to whether and where compressed air and/or vacuum should be applied. The term vacuum is understood to mean, in particular, a pressure below atmospheric pressure, which is achieved, for example, by a suitable Pump. Compressed air is understood to mean, in particular, air with a pressure above atmospheric pressure, which can also be generated by a suitable pump.

A high-performance power supply connector 240 is provided between the two zero-point clamps 220, 225. This means that a fixed tool can be supplied with high currents and/or high voltages, which go beyond the performance of other existing supply lines.

Immediately on the left and right sides of the high-performance power supply connector 240, countersinks 250, 255 are provided for fastening screws.

Currently, four first low-voltage connectors 260 and four second low-voltage connectors 265 are provided again outside of the two countersinks 250, 255. These are designed as spring-loaded contacts and can transmit voltages of up to 36 V.

Furthermore, ten first universal connectors 270 and ten second universal connectors 275 are provided on the outside. These are also designed as spring-loaded contacts and can be used, for example, to transmit signals, data or analog signals such as small currents or voltages.

It should be understood that the embodiment described here is merely exemplary and is not to be understood as restrictive in any way unless the corresponding features are incorporated into an independent claim, which of course remains reserved.

FIG. 3 shows the rest holder 300, which is currently not equipped with a tool, in greater detail. It can be seen that a total of ten universal connectors 310 are provided on the bottom of the rest holder 300, which serve to transmit data, analog signals, other signals, currents, or voltages to and from tools. These universal connectors 310 can also be used to identify tools. There are currently also four power supply connectors 320 provided, which are used to supply voltage and power to a tool being held.

A lower rail 330 and an upper rail 340 are provided on the side of the rest holder 300. These serve to hold a tool being present in the rest holder 300. For this purpose, respective recesses are present in a tool so that the tool can be pushed horizontally onto the rails and then lowered so that it is then held by the rails 330, 340 in the then occupied state. The tool can then be released from the zero-point clamps 220, 225 mentioned above, and the work holder 200 can be moved away and used for other tasks.

FIG. 4 shows a purely schematic circuit diagram of the apparatus 100. The portal 130 with the module holder 140 attached to it and its work holder 200 are shown schematically. Furthermore, a tool 150 is shown schematically, which is attached to the work holder 200 and can therefore be used to process an object. A total of four of the rest holders 300 are shown, which serve to schematically explain the functionality and structure. Three of the rest holders 300 shown have a connection to control interfaces as described below, one rest holder 300 (far left) has no such connection.

The work holder 200 is, as shown, connected via a multiplexer 410 to an electrical power supply 400, which is connected to a control unit as described below. This makes it possible to provide high electrical power, which can be output, for example, via the high-performance power supply connector 240 already mentioned above. Other power supplies, which are not shown, could also be connected and used via the multiplexer 410.

There are several control interfaces 500, 510, four of which are shown schematically here. It should be understood that in principle any number of control interfaces 500, 510 can be used accordingly to provide many functionalities and a high degree of variability. A top control interface 510 is provided among the control interfaces. Each of the control interfaces 500 and the top control interface 510 are designed here as slots for plug-in cards, so that they can easily be equipped with plug-in cards. They only have contacts 520 shown in summary, by means of which a respective electrical connection can be made to plug-in cards located therein. The contacts 520 are connected to the work holder 200 and the rest holders 300 as described below and as shown in FIG. 4.

As shown in the present case, three lines 530 extend from the work holder 200, which in the illustration in FIG. 4, left side, split from the control interface 500 being positioned on top below the top control interface 510, and thus are connected with each control interface 500 and with the top control interface 510. It should be understood that the three lines 530 shown here are merely examples and in principle any number of such lines 530 can be used.

Three lines 540 also extend from the three rest holders 300 that are shown furthest to the right, although in this case it should also be mentioned that any number of lines can be used here. These lines 540 are also each connected to all control interfaces 500 and to the top control interface 510.

By means of the mentioned lines 530, 540, currents, voltages, signals, analog signals and/or data can thus be transmitted between the work holder 200 and the control interfaces 500 and the top control interface 510 as well as between the mentioned rest holders 300 and the control interfaces 500 and the top control interface 510. The already mentioned contacts 520, to which the respective lines 530, 540 are connected, accordingly enable a corresponding exchange with plug-in cards accommodated in the control interfaces 500 and the top control interface 510. The plug-in cards, which will be discussed in more detail below, can therefore be used to control tools which are accommodated in the work holder 200 and/or in one of the rest holders 300.

A detection module 570 and a central control unit 560 are provided to detect whether there are tools in the work holder 200 and/or the rest holders 300. The central control unit 560 is directly connected to the work holder 200 in order to detect whether a tool is attached to the work holder 200. Through an additional exchange of data, for example by receiving a unique identification or a model identification of the respective tool, it can also be concluded which tool it is.

Furthermore, a CAN bus 550 is provided, which is connected to both the central control unit 560 and the detection module 570. The detection module 570 is connected to all rest holders 300 and can accordingly detect whether a respective tool is in the rest holder 300. A unique identification and/or an identification of the type can also be carried out as just described with reference to the work holder 200. Corresponding feedback can be given to the central control unit 560 via the CAN bus 550. The central control unit 560 is therefore also informed about which tools are in the rest holders 300.

A respective control unit 600 is retained in each control interface 500. The control units 600 are designed as plug-in cards and can therefore directly contact the contacts 520 of the control interfaces 500. A top control unit 700 is accommodated in the top control interface 510, which is basically designed to be equivalent to the control units 600. All following statements with reference to the control units 600 apply accordingly to the top control unit 700 with the proviso that the reference numbers to the top control unit 700 are increased by a value of 100. The top control interface 510 and the top control unit 700 are named so because they are located at the top in FIG. 4. The top control unit 700 is characterized in particular by the fact that it can control the electrical power supply 400. The central control unit 560 is not a control unit in the sense of the otherwise described control units 600, 700, which are typically assigned to a tool, but rather provides central functionality for different tools and for controlling the entire apparatus 100.

In the present case, each control unit 600 has a microprocessor 610, a tool control 620, a switch control 630 and several switches 640. The switches 640 are only designated in a summarized form. This only serves to improve the clarity of the display. Accordingly, the top control unit 700 also has a microprocessor 710, a tool control 720, a switch control 730 and several switches 740.

The microprocessor 610 controls the basic functions of the respective control unit 600. The tool control 620 provides specific functions for a respective tool, which can be, for example, the provision of current, voltage, or data as well as the reception and evaluation of data. The tool control 620 is, as shown, connected to the contacts 520 of the respective control interface 500 via the switches 640. The switches 640 are switched by the switch control 630 so that the respective control unit 600 is only connected to one of the holders 200, 300 at a specific time. It is therefore connected either to the work holder 200 or to exactly one of the rest holders 300. This allows a specific tool to be controlled. All switches 640, which establish a connection to the desired holder 200, 300, are closed. All other switches 640 are open. In an alternative embodiment, not shown, the switches can also be provided outside the control units 600, 700, for example in the control interfaces 500, 510.

To ensure proper operation, in particular a correct association between the respective tool and control unit 600, 700, all control units 600, 700 are connected to the central control unit 560. The central control unit 560 informs the control units 600, 700 via respective connections which tool is connected to which of the holders 200, 300, so that a respective control unit 600, 700 embodied for controlling that tool can switch the switches 640, 740 accordingly.

Furthermore, the control units 600 and the top control unit 700 are also connected to the already mentioned CAN bus 550. This allows universal data exchange. In particular, control units 600, 700 can each be designed to control one or more specific tools.

The central control unit 560 is designed to perform general control tasks for all or several tools, to control the entire functionality of the apparatus 100 including, for example, the already mentioned electric motors 132, 142, 144 and to coordinate the functionality of the control units 600, 700. The control units 600, 700 can, for example, send a request via the CAN bus 550 to provide a special electrical power via the power supply 400 to the central control unit 560, which then controls the electrical power supply 400 accordingly via the top control unit 700, since these are connected with each other.

The embodiment shown makes it possible to connect a respective tool both on the work holder 200 and on the respective rest holders 300 directly to an assigned control unit 600, 700. As a result, the functionalities of the respective tool in each of the holders 200, 300 can be controlled by the respective control unit 600, 700. In particular, this does not require a permanent connection to the tool, which significantly simplifies the workflow and significantly increases flexibility. At the same time, a particularly high level of flexibility in the use of tools and control units 600, 700 is ensured. A user can buy and keep in stock exactly the tools that he needs for his particular application and can use specific control units 600, 700 in the control interfaces 500, 510 for this purpose. In this way, the provision of functionalities that are not needed at all is avoided. Furthermore, a simple exchange of the individual control units 600, 700 is also possible, which means, for example, that new versions can be used or defective control units 600, 700 can be replaced.

Mentioned steps of the method according to the invention can be carried out in the order specified. However, they can also be carried out in a different order if this makes technical sense. The method according to the invention can be carried out in one of its embodiments, for example with a specific combination of steps, in such a way that no further steps are carried out. However, in principle, further steps can also be carried out, including those not mentioned.

It should be noted that in the claims and the description features may be described in combination, for example to facilitate understanding, although they may also be used separately. The person skilled in the art will recognize that such features can also be combined independently of one another with other features or combinations of features.

References in subclaims can indicate preferred combinations of the respective features, but do not exclude other combinations of features.

In order to improve readability, reference numerals for the connectors of the work holder and the rest holder have been omitted from the claims.

### LIST OF REFERENCE SIGNS

100 apparatus
110 frame
112 feet
116 manipulator
120 processing surface
130 portal
132 first electric motor
134 first rail
136 second rail
140 module holder
142 second electric motor
144 third electric motor
150 assembly tool
151 dosing tool
152 3D measuring tool
153 milling tool
200 work holder
210 suction
220 first zero-point clamp
225 second zero-point clamp
230 vacuum connector
235 compressed air connector
240 high-performance power supply connector
250 countersink
255 countersink
260 first low-voltage connectors
265 second low-voltage connectors
270 first universal connectors
275 second universal connectors
300 rest holders
310 universal connectors
320 power supply connectors
330 lower rail
340 upper rail
400 electrical power supply
410 multiplexer
500 control interfaces
510 top control interface
520 contacts
530 lines
540 lines
550 CAN bus
560 central control unit
570 detection module
600 control units
610 microprocessor
620 tool control
630 switch control
640 switch
700 top control unit
710 microprocessor
720 tool control
730 switch control
740 switch

1. Apparatus for manufacturing and/or processing objects, the apparatus comprising the following:
a work holder to which a tool can be releasably attached,
a manipulator, to which the work holder is attached and with which the work holder can be variably positioned,
one or more rest holders, wherein a tool can be releasably attached at each rest holder,
one or more control interfaces for electrical connection to at least one control unit,
wherein both the work holder and at least one rest holder each have one or more connectors for connection to a tool attached thereto, the connectors of the work holder and the at least one rest holder being electrically connected to at least one control interface.

2. Apparatus according to claim 1,
wherein a line extends from one, some or all connectors of the rest holders, the line being electrically connected to a contact of one, some or each control interface.

3. Apparatus according to claim 1,
wherein a line extends from one, some or all of the connectors of the work holder, the line being electrically connected with a respective contact of one, some or each control interface.

4. (canceled)

5. Apparatus according to claim 1,
which has a compressed air supply and/or a vacuum supply for the work holder,
wherein the compressed air supply and/or the vacuum supply are controllable from a central control unit and/or from control units being connected to the control interfaces.

6. Apparatus according to claim 1,
which has one or more electrical power supplies for the work holder and/or for the rest holders,
the electrical power supply being controllable from a central control unit and/or from one or more control units being connected to the control interfaces.

7. Apparatus according to claim 6,
comprising at least one multiplexer configured to selectively connect one of a plurality of electrical power supplies to one or more connectors of the work holder and/or the rest holders.

8. Apparatus according to claim 1,
wherein each control interface has one or more electrical contacts, each contact being electrically connected to one or more connectors and being connectable to a control unit.

9. Apparatus according to claim 1,
wherein some or all connectors are designed as electrical contacts or plugs.

10. (canceled)

11. Apparatus according to claim 1,
wherein the control interfaces are designed as slots for control units in the form of electronic plug-in cards.

12. (canceled)

13. Apparatus according to claim 1,
wherein the manipulator is designed as a portal system.

14. (canceled)

15. Apparatus according to claim 1,
wherein the tool or tools are connectable to the control interfaces or control units exclusively by means of via the connectors of the work holder and the rest holder or the rest holders.

16. Apparatus according to claim 1,
wherein the work holder is configured to hold a tool by applying spring force and to release it by applying compressed air.

17. Apparatus according to claim 1,
wherein one, some or all of the rest holders have one or more rails onto which a tool can be inserted from above, and wherein the tool can be placed on a bottom of the rest holder.

18. (canceled)

19. Apparatus according to claim 1,
wherein the connectors for transmitting data and/or electrical energy between tool and control unit are connected to the respective control interface.

20. Apparatus according to claim 1 one of the preceding claims,
comprising a central control unit;
wherein the central control unit is connected to one, some or all control interfaces and/or control units,
and/or
wherein the central control unit is designed to control the manipulator.

21. Apparatus according to claim 1,
which has one or more tools which are attached to the work holder or to a respective rest holder, and
which has one or more control units, each control unit being connected to a respective control interface for controlling one or more tools.

22. Apparatus according to claim 21,
wherein one, some or all of the tools have an electronic tool identification, and
wherein these tools are configured to transmit their electronic tool identification using at least one connector to a central control unit and/or to at least one control unit being connected to a control interface and/or to a detection module.

23. Apparatus according to claim 21,
wherein at least one tool, or several tools, is/are a tool for additive manufacturing, a milling tool, a measuring tool, a dosing tool, an assembly tool, a laser engraving tool, an adhesive tool, or a rotary knife.

24. Method for manufacturing and/or processing an object, the method comprising the following steps:
attaching at least one tool to a rest holder, the tool being electrically connected to a control unit being assigned to the tool using at least one connector of the rest holder, while the tool is attached to the rest holder,
releasing the tool from the rest holder and thereby attaching the tool to a work holder, the tool being electrically connected to a control unit being assigned to the tool using at least one connector of the work holder, while the tool is attached to the work holder,
positioning the tool via a manipulator to which the work holder is attached, thereby producing and/or processing the object using the tool.

25. (canceled)

26. Method according to claim 24,
wherein the tool is connected to the control unit exclusively via the connectors of the rest holder and/or the work holder.
